(19) United States
(12) Patent Application Publication
(10) Pub. No.: US 2007/0010198 A1
(43) Pub. Date: Jan. 11, 2007

(54) Method and apparatus for utilizing selective signal polarization and interference cancellation for wireless communication

(76) Inventor: David L. McKay SR., Duluth, GA (US)

Correspondence Address: TROUTMAN SANDERS LLP, 600 PEACHTREE STREET , NE, ATLANTA, GA, 30308, US

(21) Appl. No.: 10/470,656

(22) Filed: Dec. 7, 2000

Related U.S. Application Data
(60) Provisional application No. 60/169,419, filed on Dec. 7, 1999.

(51) Int. Cl. H04B 1/60; H04B 17/02

(52) U.S. Cl. 455/10

(57) ABSTRACT

A wireless communication system which combines transmissions which utilize vertically polarized signals and horizontally polarized signals to extend communication range and/or system capacity.

### PRIORITY CLAIM

This application claims the benefit of U.S. Provisional Patent Application Ser. No. 60/169,419, filed 7 DEC. 1999, entitled “Method and Apparatus for Utilizing Selective Signal Polarization and Interference Cancellation.” This provisional application is incorporated herein as if fully set forth.

### BACKGROUND OF THE INVENTION

1. Field of the Invention

The present invention relates in general to wireless communication systems, and in particular to systems which extend communication range and system capacity.

2. Description of the Prior Art

Repeaters serve the wireless communication market well in extending tower coverage but, like all devices, repeaters have their limitations. Base stations have issues that limit their use at times; such issues include high equipment cost, software licensing fees, T1 monthly recurring costs, and site acquisition costs.

As a general rule all repeaters require isolation between the donor and server antennas. Since the repeater both receives and transmits on the same frequency, sufficient isolation must be maintained between the two antennas that is 15 dB greater than the overall system gain. How does this effect their usage in the system? If adequate isolation cannot be obtained on the structure, the repeater may not be able to provide its rated output power and/or gain. Thus, it will limit the repeater to using a directional antennas as the server antenna. Repeaters are easily used for in-building applications where isolation between the antennas is easily achieved because of the building structure. Additional repeater problems vary from protocol to protocol. A few of these problems will now be specifically discussed.

CDMA repeaters are not selective on which site is being retransmitted (since all cell sites in the system are transmitted on the same frequency) and in dense cell site areas they can actually cause a problem known as “pilot tone pollution” by amplifying several cell site signals. Although this can be minimized, many times the only other solution is the use of another base station.

GSM repeaters have become less usable with the implementation of frequency hopping since the repeater must be equipped with several channels and thus becomes too expensive for most applications. Base station prices have dropped significantly in this market but they still require recurring charges such as software licensing fees and T1 backhaul costs.

AMPS/TDMA systems, which are channel selective repeaters, are not practical because of the signal delay through the repeater would exceed the equalization capability of the subscriber unit when both the repeater and the base station signals are received. Broad band repeaters would amplify and transmit adjacent cell signals in addition to the desired cell site signals. Frequency translating repeaters offer a solution to this problem but present their own set off issues to deal with, such as call processing, hand off back to the donor cell or other adjacent cells, to name a few.

IDEN systems have not used repeaters except to provide facility coverage due to channelization signals delays and the service providers not owning contiguous frequency bands (potentially interfering with their neighbors).

### SUMMARY OF THE INVENTION

It is one objective of the present invention to provide a wireless communication system which combines transmissions which utilize vertically polarized signals and horizontally polarized signals to extend communication range and/or system capacity.

It is another objective of the present invention to utilize adaptive interference cancellation (AIC) in order to extend communication range and/or system capacity in a multitower wireless communication system.

The above as well as additional objectives, features, and advantages will become apparent in the following description.

### BRIEF DESCRIPTION OF THE DRAWINGS

The novel features believed characteristic of the invention are set forth in the appended claims. The invention itself however, as well as a preferred mode of use, further objectives and advantages thereof, will best be understood by reference to the following detailed description of the preferred embodiment when read in conjunction with the accompanying drawings, wherein:

FIG. 1A is a simplified pictorial representation of the prior art technique of utilizing three sectors of vertically polarized electromagnetic signals to communicate from a wireless tower.

FIG. 1B is a depiction of the utilization of the present invention to “remote” a dedicated sector.

FIG. 1C is a pictorial representation of the utilization of the present invention for “simulcasting” a particular sector.

FIG. 2 is a block diagram representation of the basic interference cancellation utilized in the preferred embodiment of the present invention.

FIG. 3 is a block diagram representation of cancellation at a remote base station.

FIG. 4 is a pictorial and block diagram representation of simulcasting to a wireless remote based station.

FIG. 5 is a pictorial and block diagram representation of the cancellation of feedback in accordance with the preferred embodiment of the present invention.

FIG. 6 is a pictorial and block diagram representation of the cancellation of down link interference in accordance with the preferred embodiment of the present invention.

FIGS. 7, 8, and 9 are block diagram and pictorial representations of one specific implementation of the preferred embodiment of the present invention.

### DETAILED DESCRIPTION OF THE INVENTION

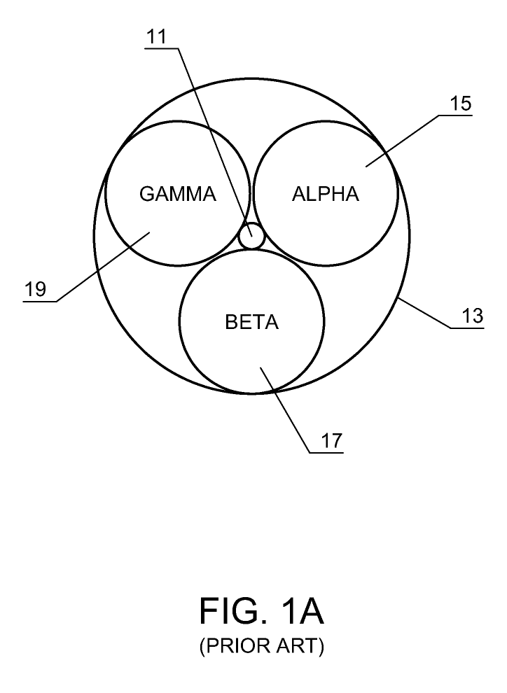

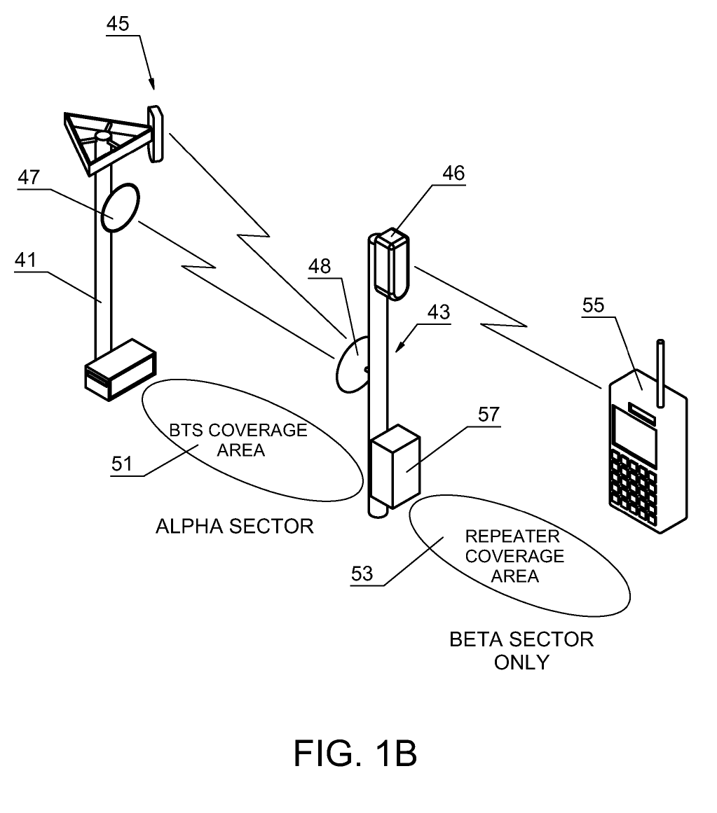

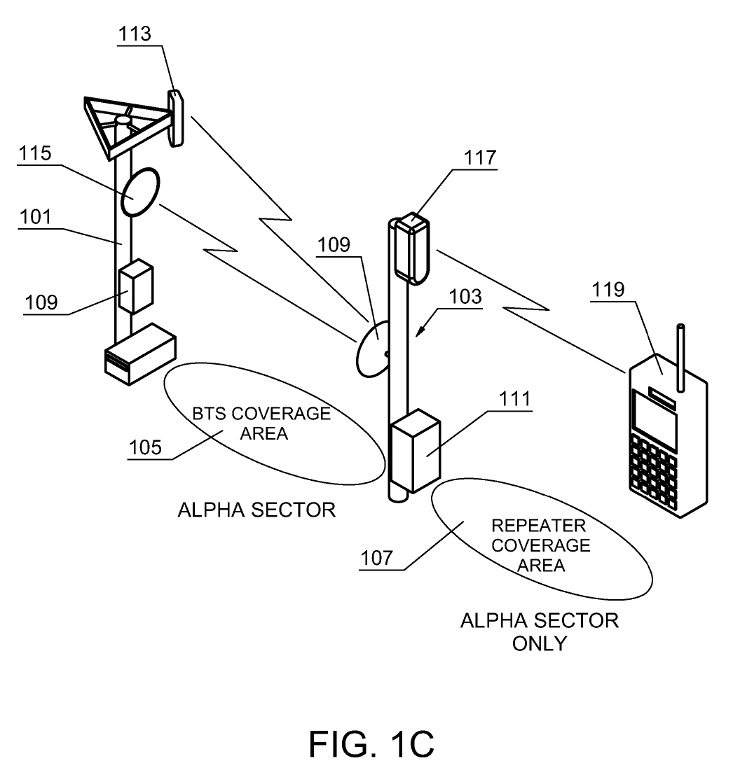

FIG. 1 A is a simplified pictorial representation of the transmission of wireless communications from a tower 11. The tower 11 has a range of coverage 13 which extends outward from tower 11. In most wireless communications, such as cellular and PCS telecommunications, the signals being transmitted and received by tower 11 are vertically polarized elements of electromagnetic waves. The coverage 13 of tower 11 is customarily segmented into three sectors each of which spans 120 degrees. The sectors are identified as an alpha sector 15, a beta sector 17, and a gamma sector 19. In most conventional wireless communication systems, horizontally polarized elements of electromagnetic fields are not typically or commonly utilized to transmit communications. The preferred embodiment of the present invention utilizes combinations of transmissions which are made utilizing vertically polarized elements of electromagnetic waves and transmissions utilizing horizontally polarized elements of electromagnetic waves, in order to extend tower coverage and/or to increase tower capacity. One potential use of the present invention is that of “remoting” from a donor antenna to a server antenna in order to extend the range of antenna coverage. In this manner, the two antenna towers cooperate to provide for a greater geographic range of coverage. FIG. 1C depicts an alternative utilization of the present invention; namely, that of simulcasting a (single and uniform) sector between two towers. These two specific implementation will now be discussed.

As is shown in FIG. 1B, tower 41 transmits utilizing vertically polarized elements of electromagnetic waves utilizing transmitter 45. In this particular instance, tower 41 transmits in the alpha sector utilizing vertically polarized elements of electromagnetic waves. In accordance with the present invention, tower 41 will also transmit horizontally polarized electromagnetic waves in the beta sector utilizing transmitter 47.

Both the vertical and horizontal signals are received at tower 43 through a dual pole donor antenna 48. The received vertically polarized transmission in the alpha sector 51 and the horizontally polarized transmission in the beta sector are processed by wireless base station link 57 (which will be described in detail below). The output of the wireless base station link 57 is then provided to the transmission equipment of the server antenna 46 of tower 43. Tower 43 transmits vertically polarized wireless signals in the beta sector, which are received by mobile communication devices such as wireless/PCS phone 55. The example of FIG. 1 B depicts the utilization of particular sectors such as alpha sector 51 and beta sector 53. Alternative sectors may be utilized in accordance with the present invention. For example, tower 41 can transmit in the beta sector while tower 43 transmits in the alpha sector. Alternatively, tower 41 can transmit in the gamma sector while tower 43 transmits in the alpha sector. For an alternative example, tower 31 can transmit in the beta sector and tower 43 can transmit in the gamma sector. In other words, any combination of dissimilar sectors can be utilized to extend the coverage range of the donor tower which is tower 41, without encountering signal interference problems.

FIG. 1C depicts an alternative use of the present invention in which “simulcasting” utilizing cooperating towers is enabled. As is shown, tower 101 has coverage through utilization of the alpha sector 105 utilizing vertically polarized elements of electromagnetic transmissions. The tower 101 is equipped with alpha sector transmission equipment 113, as well as with transmission equipment 115 which allows for the transmission of horizontally polarized electromagnetic transmissions. In the example of FIG. 1C, horizontally polarized alpha sector transmission are also utilized. As is shown, tower 103 includes a dual pole donor antenna 109 which is adapted to receive both vertically polarized electromagnetic transmissions as well as horizontally polarized electromagnetic transmissions. Tower 103 is also equipped with wireless base station link 111 which processes the vertical and horizontal signals and supplies its output to the server antennas vertical transmission system 117. Tower 103 utilizes the vertically polarized electromagnetic signals to provide repeater coverage in the alpha sector only. Mobile phone 119 may communicate with tower 103 through use of the vertically polarized alpha sector transmissions. As is shown in FIG. 1C, tower 101 may also be equipped with a wireless transmission hub 109.

Preferably, the present invention utilizes Adaptive Interference Cancellation (AIC) techniques to select only the desired base station transmission for rebroadcast. AIC can be utilized for any protocol including TDMA, CDMA, GSM, IDEN or AMPS. CDMA systems broadcast all of their cell sites on the same RF channel and are differentiated only by their PN codes. AIC provides up to 45 dB of selectivity to the desired sector IPN code) to be re-radiated at the remote base station location. Additional isolation provided by AIC between the received signal and the rebroadcast signal will allow an Omni-directional antenna to be used at the remote base station location. Adaptive Interference Cancellation provides an interesting tool to resolve many of these issues. Fundamentally you can think of AIC operation much the same as a feed forward amplifier. Properly implemented into a wireless network it can:

1. Simplified Installation: The signal cancellation between the received signal and the transmitted signal effectively provides up to 30 dB of additional system isolation plus the effective difference achieved with polarization.

2. Reduced RF Signal Delay In the Repeater: Since the only signals received are the RF signals in the horizontal plane all of the signals effectively In the vertical plane are cancelled up to three times the isolation between the two signals provided by polarization. This eliminates the need for channelization thereby reducing the signal delay through the repeater. The system can now effectively be used for most protocols. Band selective filtering is still recommended because service providers in the adjacent band could be using cross polarization which will not allow AIC to achieve the desired degree of isolation alone.

3. Improved Donor Site Selectivity: The improved isolation minimizes the receipt of interfering signals from other cell sites, other sectors on the donor site, or other service providers receiving and amplifying several cell sites.

4. Higher RF Output Power and Gain: This can be achieved because of the improved isolation achieved between the donor and server antennas.

5. Omni-Directional Remote Site Coverage. This is now possible, depending on the RF power output and gain required, due to the improved isolation between the donor and the server antenna.

6. Improved System Capacity: This can now be provided by the AIC repeater since dedicated sectors can be remoted to provide coverage in dense user areas where sites do not allow larger base station equipment to be located.

7. Reduction in Operating Costs: This achieved by eliminating the need for additional T1 facilities and site acquisition cost are typically lower for repeater equipment.

AIC provides the donor site selectivity of 45 dB. This eliminates the need for additional channel selective filtering normally required for an over the air repeater site. This broadens the use of the present invention to allow use with narrow band channel systems such as TDMA, IDEN and AMPS. AIC improved selectivity of the donor site eliminates the need for narrow band active filtering (down conversion and SAW IF filters. The elimination of these narrow band filters also reduces the system signal delays introduced by repeaters into the network. RF signal delays cause equalization problems with subscriber units when the repeated signal and the donor transmission signal are both present; delays also require the search windows to be opened wider in a CDMA system.

AIC improved selectivity of the donor signal greatly reducing the rebroadcast of PN codes at a level that would cause PN code pollution in a CDMA network. For systems utilizing other protocol methods (AMPS, IDEN, GSM, TDMA) the AIC selectivity of the donor site reduces rebroadcast of undesired cell site signals in the azimuth of the donor antenna on the Wireless Base Station Link.

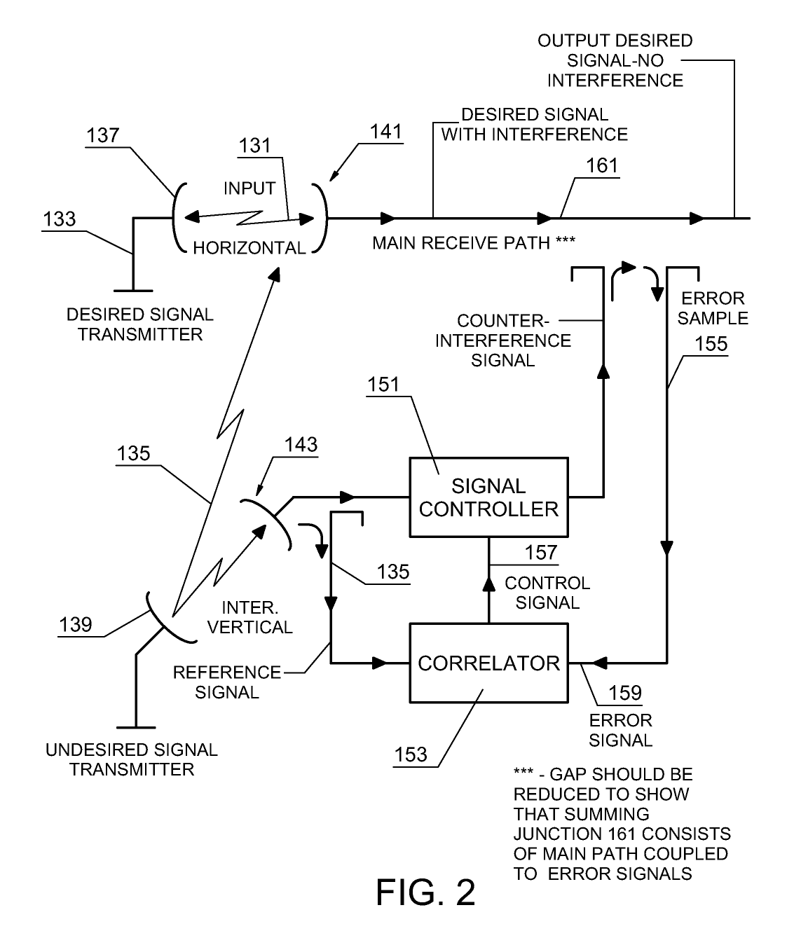

FIG. 2 is a basic cancellation block diagram of the preferred AIC implementation. As illustrated, the primary signal from the donor site 133 is received on the horizontal element of the remote donor antenna 137. The interfering signals 135 are received on the vertical polarized element of the remote donor antenna 137. Interfering signals 135 could be signals from other sectors on the server cell site, other cell sites in the azimuth pattern of the antenna and our own signal broadcast from the system output reradiation (rerad) antenna. All of the undesired signals are broadcast from antennas that are vertically polarized. The horizontal polarization of the donor antennas allow up to 20 dB of selectivity improvement. AIC will improve the signal selectivity by three times the actual isolation provided by cross polarization. Since, in actual practice, the theoretical selectivity achieved by cross polarization is rarely achieved, we use 15 dB and therefore specify AIC provides up to forty-five dB of selectivity.

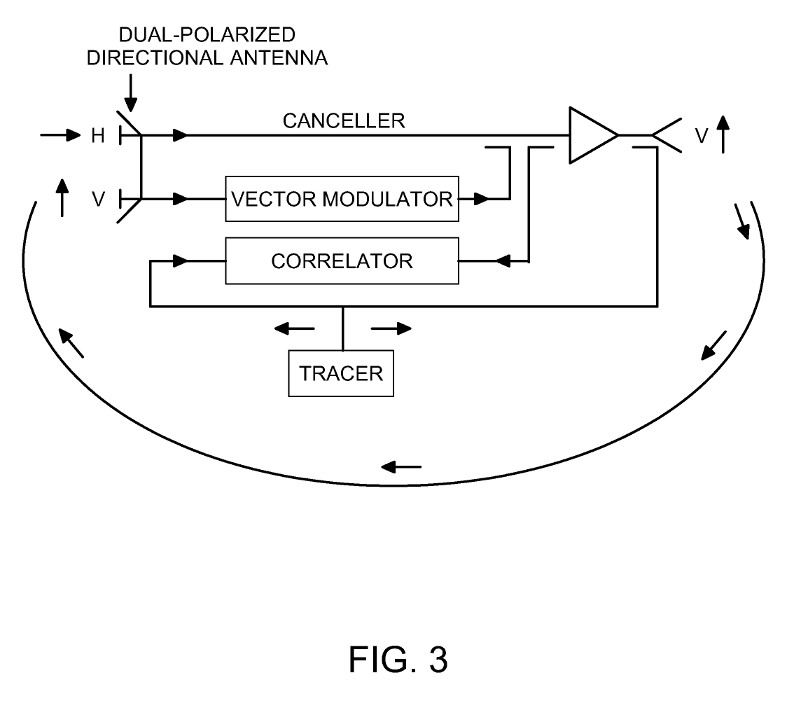

As is shown in FIG. 3, a tracer signal is used as to “tag” the output signal, “V” for use as a cancellation reference. When the tracer signal finds its way back to the input, it is cancelled along with the associated feedback signal spectrum, thus achieving isolation. Multiple feedback signals are also cancelled since the reference and receive antenna phase centers are also collocated.

Both tracer signals one from the donor base station and the tracer signal originated in the other in the remote base station circuit, are for a correlation. Referencing the phase relationship with the originating signal in time allows the system to improve selectivity of the desired signal versus the signals requiring cancellation.

Referring again to FIG. 2, the desired signal 131 from the base station is received on the horizontal polarized donor antenna element 141 of a dual polarized antenna and the output of the repeater is transmitted by the server vertical polarized antenna. The desired signal 131 is amplified through the repeater without any effect. The interference reference signals 135 are received on the vertical polarized element of the donor antenna 139 and this includes undesired cell site signals as well as our own signal transmitted. The signal controller 151 receives the interference reference signals 135 with a small amount coupled to the correlator 153. At the output of the repeater a small amount of signal is coupled to look at an error sampling 155 of the undesired signals. With the use of the error signal 159 and the interference reference signal sampling the correlator 153 sends a control signal 157 to the controller 151 to adjust the counter interference signal to the proper phase. The interfering signals received with the desired signals are combined with the counter interference signals out of phase at the summing junction 161 thereby canceling the interfering signals. AIC can effectively achieve cancellation up to three times the signal isolation between the desired and undesired signals received on the different polarized elements. As an example, if 15 dB of isolation is achieved with polarization the AIC circuit will achieve 45 dB of selectivity to the desired signals. Only the forward path is illustrated but for the repeater to achieve balance AIC is required in both the forward and reverse signal paths.

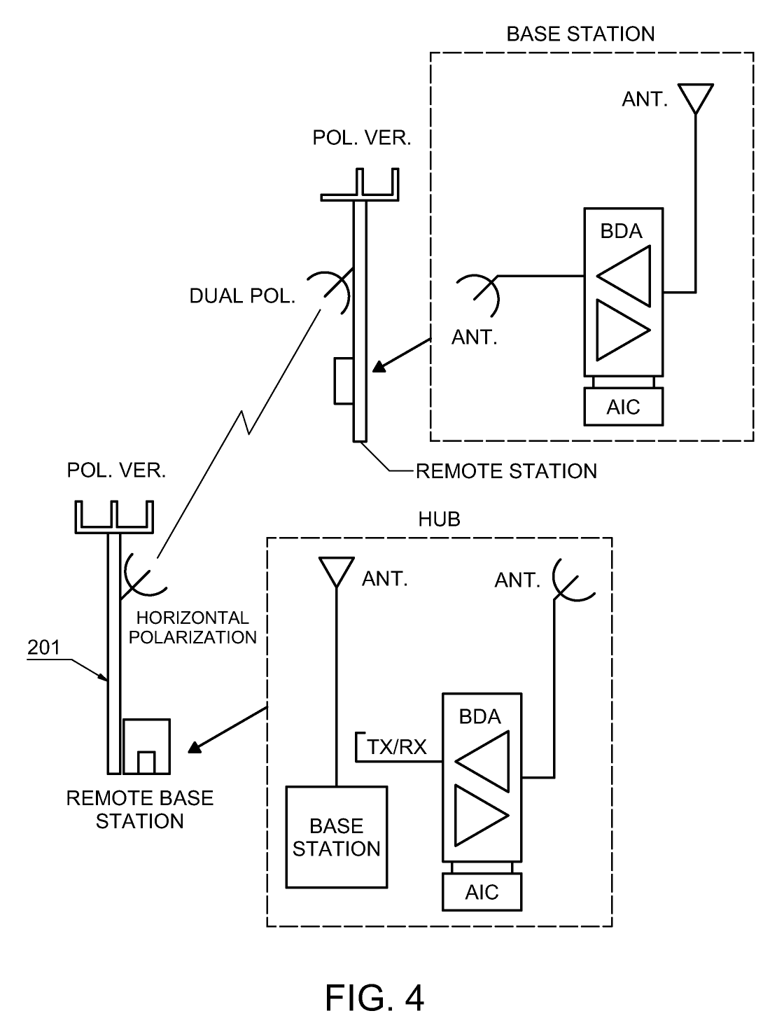

FIG. 4 illustrates a method of simulcasting the same base station at a remote location. Utilizing AIC allows the remote site 201 several advantages over using a conventional repeater product offered on the market today. The remote site 201 requires less antenna isolation therefore higher gain can be achieved in the repeater which, allows higher RF power output and/or the use of a Omni-directional antenna as the rerad antenna. Since AIC cancels all signals expect those received from the base station (as previously explained) this allows a reduction in the filtering required in the repeater. This reduction in signaling minimizes the signal delay through the repeater. Since the delay is minimized narrow band signals can now be repeated with the same effective adjacent channel. Selectivity is actually not channel specific but donor site and polarization specific selectivity as the broadband systems.

At the base station a directional coupler is used to tap a small portion of the transmitter signals and to inject the receive path signals from the remote base station. The hub provides the amplification required to interface both forward and reverse path signals with the base station. AIC is used to provide the selectivity on the reverse path for only those reverse path signals transmitted from the remote base station. This reduces the filtering required on the reverse path signals at the donor site. The simulcast system provides an array of user features:

1. Omni-Directional Radiation at remote;

2. Improved isolation between donor and rerad antenna;

3. Reduced signal delay;

4. Eliminates requirement for narrow band filtering;

5. Higher RF power output;

6. Improved isolation allows additional system gain; and

7. Use with narrow band protocol systems such as TDMA, AMPS, and IDEN.

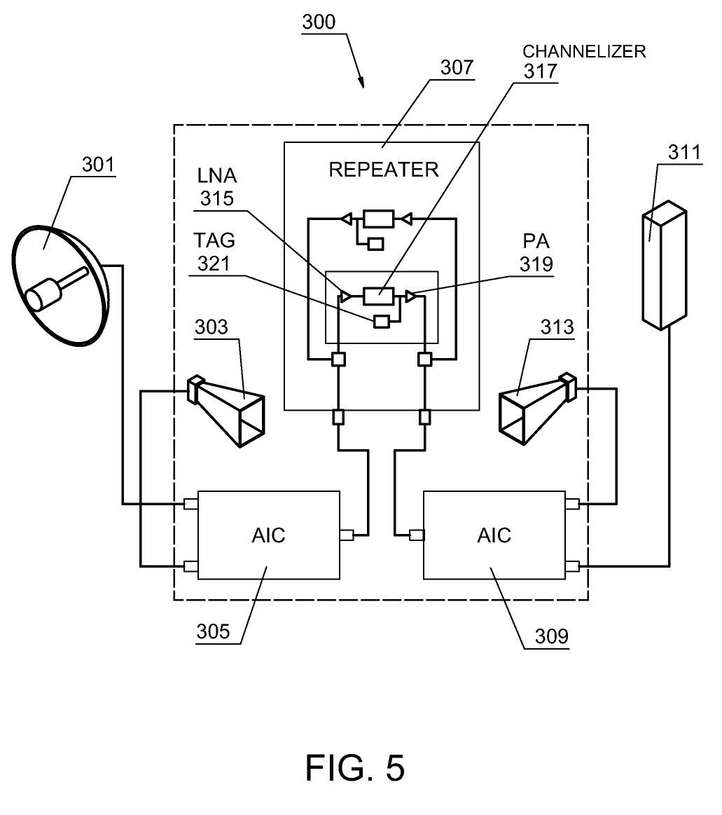

FIG. 5 is a block diagram representation of one particular implementation of the present invention which is designed for the purpose of canceling feedback to prevent oscillation. As is shown, a donor antenna 301 is provided which is typically a dish-type antenna, and which is used to transmit and receive signals to and from a base station. A second donor side horn antenna 303 is provided and operates to receive feedback signals from the server antenna. It feeds them directly into the reference port of AIC device 305. The donor antenna 301 connects to the receive port of AIC device 305. Note that the horn antenna 303 can be replaced by any traditional antenna with the appropriate gain and frequency for the given application. The signal processing device 300 includes two adaptive interference cancellation modules, namely AIC 305 and AIC 309. AIC 305 has an output which is coupled to the “donor port” of repeater 307. In contrast, AIC 309 has an output which is connected to the “server port” of repeater 307. AIC 309 is connected to a server antenna 311 and a horn antenna 313. Server antenna 311 is typically a panel-type antenna. It is used to transmit and receive signals to and from mobile users. Horn antenna 313 is a server side horn antenna which receives the feedback signals from the donor antenna and feeds them directly into the AIC reference port to be cancelled. Repeater 307 uses a tracer signal to tag the output signal. When the AIC detects the tag at the input, it cancels it along with that portion of the output that is fed back to the input.

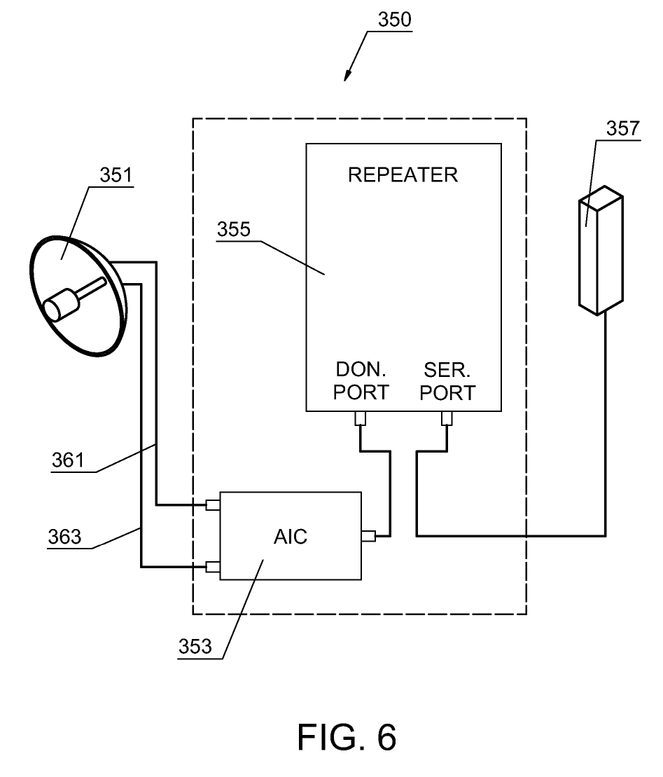

FIG. 6 is a block diagram representation of an alternative utilization of the present invention, namely the canceling of downlink interference. As is shown, a dual pole donor antenna 351 is provided. It operates to transmit and receive signals to and from a donor base station via the horizontal polarization. It receives signals from all base stations within its beam width via the vertical polarization. Each polarization (vertical and horizontal) are fed to a signal processing system 350 with independent coaxial connections. The dual pole donor antenna 351 is designed such that both the vertical and horizontal polarizations are phase matched within one degree. As is shown, the horizontal polarization represents the desired signal from a downlink. The desired signal passes through a coaxial connection 361 to the receive port of automatic interference cancellation system 353. For uplinks, amplified mobile signals pass directly through the receive port of ACI system 353 to the horizontal output of the dual pole antenna 351. Coax 363 is provided to connect the vertical polarization (which is representative of interference) for the downlink only. Interference passes through coax 363 to the reference port of ACI system 353. ACI system 353 uses the vertically polarized signals as a reference to cancel interference on the receive port of ACI system 353. For downlinks, the desired signal output of the ACI is connected directly to the donor port of repeater 355. For uplinks, the donor port output connects to the ACI output and passes directly through the ACI. For downlinks, repeater 355 operates to amplify and retransmit the desired signal to a server antenna 357 which then sends the signal to mobile users. For uplinks, the repeater 355 amplifies and retransmits mobile signals to the output of the AIC system 355. Server antenna 357 is typically a panel-type antenna, and is used to transmit and receive signals to and from mobile users.

Attached as Appendix 1 find a preliminary evaluation report on the operation of the automatic interference cancellation system. It describes tests which were conducted in order to quantify and prove the operation of the automatic interference cancellation system.

EXEMPLARY TRIAL: The CDMA trial described below provided a means to remote a lightly loaded sector to a building 401 requiring coverage and potentially more capacity than could be supported by the sector currently providing minimal coverage to the facility.

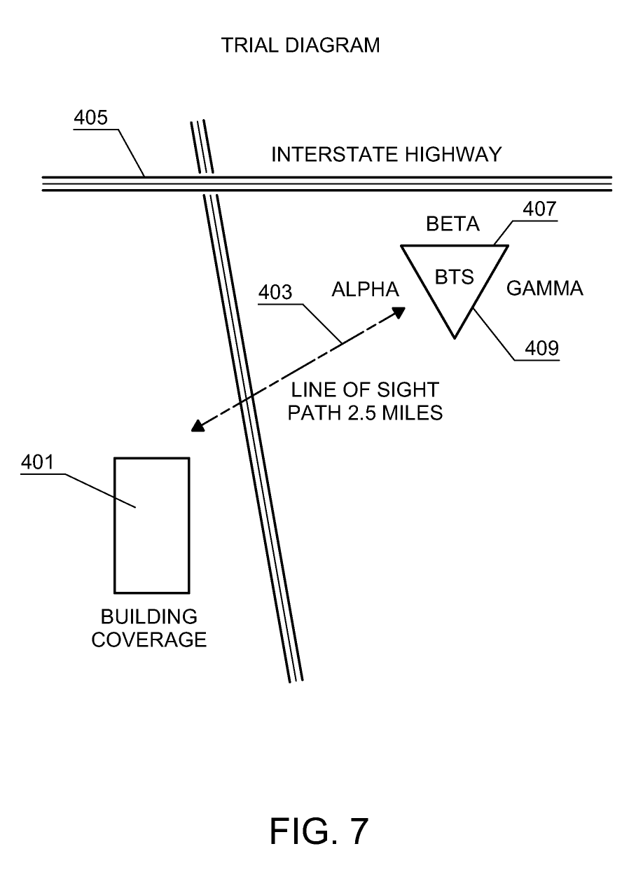

As illustrated in FIG. 7, the building 401 was covered by the alpha sector 403 of the BTS, which also as providing coverage for a major interstate highway corridor 405, as was the beta sector 401. Since these sectors were heavily loaded due to the capacity requirements, it was desired to provide coverage to the facility with the gamma sector 409 which was lightly loaded. In this particular application, it was also desired to remote a non-commercial service provider's lab system to the facility to accommodate testing in their own facility.

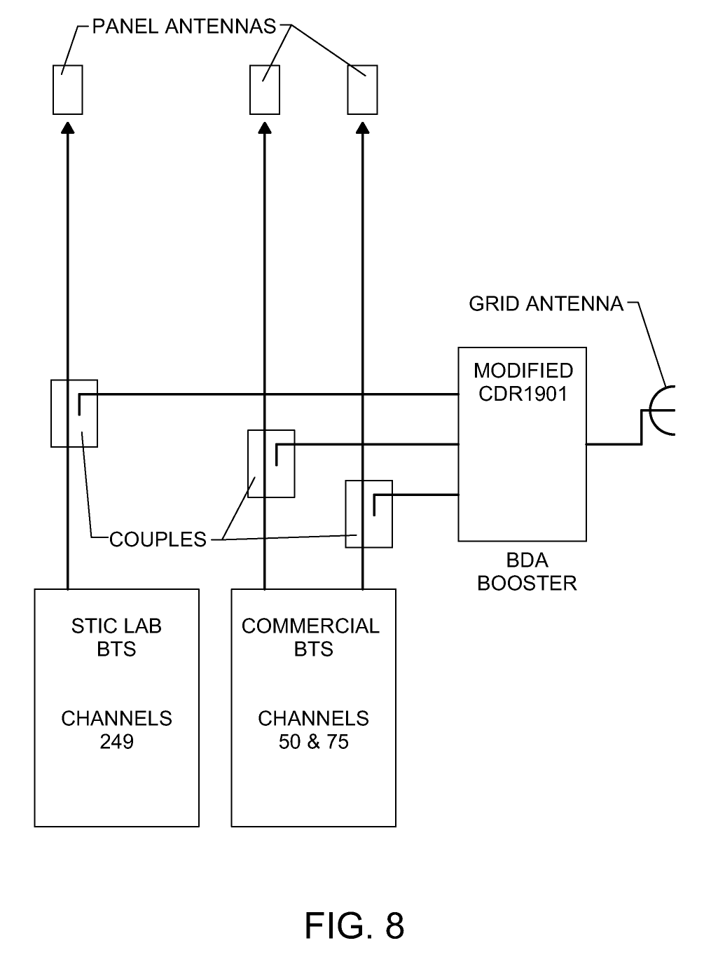

FIG. 8 illustrates how a directional coupler was placed into the coaxial cable path of each of the BTS paths that were to be remoted to the facility. These RF signals (Commercial RF channels 50 and 75, Plus lab RF channel 249) were then combined into a booster amplifier which fed a horizontally polarized link dish antenna. The booster amplifier also provided gain to the up link RF signals to overcome the insertion lose of the directional couplers.

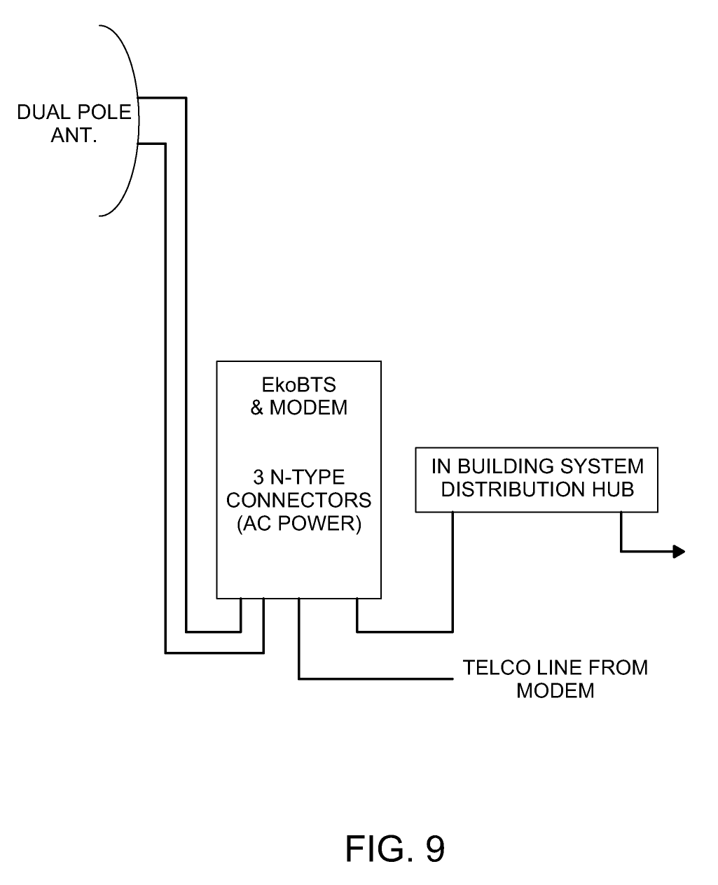

As depicted in FIG. 9, at the building 401 being covered an EkoBTS wireless base station link was mounted in an equipment room and the dual pole feed antenna was mounted on the roof of the building 401. The output of the EkoBTS wireless base station link is connected to an in building distribution system to provide the desired sector coverage throughout the facility.

The test was to ensure that the desired RF signals (gamma sector, plus lab) were being selected by the EkoBTS wireless base station link and the undesired Alpha sector was being cancelled. This would provide coverage on the desired PN in the facility and off load the capacity onto the gamma sector as desired. An additional concern was if the horizontal polarization isolation and narrow beam antennas prevent gamma sector from being selected by the subscriber units in the RF link path outside of the desired facility.

With the booster turned off the alpha sector was monitored on each element of the dual pole dish antenna at the facility. On the horizontal the composite power was monitored to be −61 dBm, and the vertical element composite power was −40 dBm. The horizontal element was connected to the desired input of the Adaptive Interference Cancellation module (AIC) and the vertical element was connected to the undesired or interference input. These two lines from the elements were phase matched with a TDR. With the AIC off and monitoring the output the undesired signal was monitored at a level of −61 dBm composite power. With the AIC turned on the level dropped to −92 dBm composite power.

The booster was turned on and the desired signal level plus the undesired signals were monitored at the output of the AIC at a composite level of −46 dBm. Since the desired and undesired signals are on the same frequency it is not possible to get an accurate reading of the desired signals only since both are always present. Plus, this was a commercial system and it was not possible to turn off the alpha sector so we could monitor the horizontal signals without the vertical transmission from the alpha sector. The link path RF output power was intentionally set 6 dB lower to assist in maintaining the alpha sector as the dominant sector to the subscriber units. This gave the alpha sector up to 27 dB of preference over the gamma sector link signals, dependent on how the subscriber unit was positioned for antenna polarity, the dominant PN carrier in the facility is the gamma Sector.

Although the invention has been described with reference to a particular embodiment, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

1. (canceled)

2. In a terrestrial telecommunication system, a wireless communication apparatus comprising:
a first receiver to receive a desired signal and an undesired signal, the desired signal having a first polarization and the undesired signal having a second polarization;
a second receiver to receive the undesired signal;
a cancellation module coupled to the second receiver to receive the undesired signal and to provide a counter-interference signal based at least partially on the undesired signal; and
a summing module to receive the counter-interference signal, to combine the desired and undesired signals with the counter-interference signal so that the counter-interference signal cancels the undesired signal based at least partially on the second polarization, and to provide the desired signal as an output.

3. The apparatus of claim 2, wherein the first receiver is a dual-polarized donor antenna adapted to receive vertical and horizontal polarized signals, and wherein the desired signal has a horizontal polarization and the undesired signal has a vertical polarization.

4. The apparatus of claim 2, further comprising a single polarization server antenna coupled to the summing module to receive and transmit the output.

5. The apparatus of claim 2, wherein the undesired signal partially comprises a feedback component associated with the output.

6. The apparatus of claim 2, further comprising a tracer module to receive and tag the output and provide a tracer signal associated with the output to the cancellation module, wherein the cancellation module provides the counter-interference signal based at least partially on the output such that feedback associated with the output is cancelled.

7. The apparatus of claim 2, wherein the desired signal and the undesired signal are received in a first sector and the desired signal is provided in one of the first sector or a second sector.

8. The apparatus of claim 2, the cancellation module comprising a correlator operatively coupled to a controller, wherein the correlator and the controller receive the undesired signal, and the correlator receives an error signal associated with the output and provides a control signal to the controller to adjust the phase associated with the counter interference signal.

9. A wireless communication system comprising:
a base station comprising a base station antenna to receive a transmission, a dual polarization feeder antenna to provide a desired signal, and a first adaptive interference cancellation (“AIC”) circuit operatively coupled to the base station antenna to receive the transmission and operatively coupled to the dual polarization feeder antenna;
the first AIC circuit being adapted to at least partially cancel a component of the transmission based on a polarization characteristic associated with the component of the transmission such that the desired signal is isolated from the wireless transmission;
a repeater wirelessly linked to the base station, the repeater comprising a dual polarization donor antenna to receive the desired signal, a server antenna to provide an output signal, and a second AIC circuit operatively coupled to the donor antenna and the feeder antenna; and
the second AIC circuit being adapted to cancel interference associated with the desired signal based at least partially on a polarization characteristic associated with the interference such that the interference is isolated from the desired signal and the desired signal is provided as the output signal.

10. The system of claim 9, wherein at least one of the first and second AIC circuits comprises a signal controller to adjust a phase characteristic associated with a counter-interfering signal provided by one of the first AIC circuit or the second AIC circuit used to isolate the desired signal based at least partially on a feedback signal associated with the desired signal.

11. The system of claim 9, wherein the base station and the repeater each comprise a bi-directional amplifier operatively coupled to one of the first AIC circuit or the second AIC circuit, the bi-directional amplifier operatively configured so that the base station and the repeater communicate wirelessly in a bidirectional manner.

12. The system of claim 9, wherein at least one of the first AIC circuit and the second AIC circuit are adapted to isolate the desired signal from an undesired signal based on characteristics associated with a donor site providing the desired signal.

13. A terrestrial based wireless communication device comprising:
a terrestrial based repeater configured to transmit wireless communications via uplink and downlink transmissions, the repeater comprising a donor port and a server port, each receiving and providing uplink and downlink transmissions;
a first adaptive interference cancellation (“AIC”) module coupled to the donor port of the repeater, the first AIC module adapted to receive a first reference signal and a first wireless transmission, to cancel a portion of the first wireless transmission based on the first reference signal, and to provide a first desired signal to the donor port of the repeater; and
a second AIC module coupled to the server port of the repeater, the second AIC module adapted to receive a second reference signal and a second wireless transmission, to cancel a portion of the second wireless transmission based on the second reference signal, and to provide a second desired signal to the server port of the repeater.

14. The device of claim 13, wherein the first reference signal comprises feedback associated with a transmission originating from the server port of the repeater and the second reference signal comprises feedback associated with a transmission originating from the donor port of the repeater.

15. The device of claim 13, the repeater further comprising a tracer signal generation module to generate a tracer signal,
the repeater being adapted to tag a transmission provided on at least one of the donor and server ports of the repeater with the tracer signal, and
wherein at least one of the first and second AIC modules is adapted to cancel a portion of the first or second wireless transmission based upon the tracer signal.

16. The device of claim 13, wherein at least one of the first and second AIC modules cancels a portion of the first or second wireless transmissions based upon a polarization characteristic associated with one of the first wireless transmission or second wireless transmission.

17. The device of claim 13, wherein the first wireless transmission and the second wireless transmission originate from different signal sectors and the first desired signal and the second desired signal are transmitted to different signal sectors.

18. A wireless communication method comprising:
receiving one or more wireless transmissions comprising components having different polarization characteristics;
providing a reference signal corresponding to at least one undesired component of the one or more wireless transmissions; and
isolating a predetermined component of the one or more wireless transmissions based on a polarization characteristic associated with the reference signal to provide the predetermined component as a desired signal.

19. The method of claim 18, wherein the reference signal comprises a feedback interference component associated with the desired signal.

20. The method of claim 18, wherein the one or more wireless transmissions comprises vertical polarized elements and horizontal polarized elements and the reference signal corresponds to the vertical polarized elements such that the desired signal comprises horizontal polarized elements.

21. The method of claim 18, further comprising providing a counter-interference signal based on the reference signal to combine with at least one of the one or more wireless transmissions so that a portion of the one or more wireless transmissions in cancelled so that the desired signal is isolated from the one or more wireless transmissions.
